(19) United States
(12) Patent Application Publication
(10) Pub. No.: US 2008/0254227 A1
(43) Pub. Date: Oct. 16, 2008

(54) Method for Coating a Component

(76) Inventors: Thorsten Stoltenhoff, Ennepetal (DE); Klaus Gorris, Bottrop (DE)

Correspondence Address: PRAXAIR, INC.;LAW DEPARTMENT - M1 557, 39 OLD RIDGEBURY ROAD, DANBURY, CT, 06810-5113, US

(21) Appl. No.: 12/089,648

(22) PCT Filed: Oct. 12, 2006
(86) PCT No.: PCT/DE2006/001797

§ 371 Date: Apr. 9, 2008

(30) Foreign Application Priority Data
Oct. 19, 2005 (DE) 10 2005 050 045.5

(51) Int. Cl. B05D 1/02

(52) U.S. Cl. 427/447

(57) ABSTRACT

A method for coating a member of fiber-reinforced composite material is proposed, wherein
(a) at first a composite consisting of organic and metallic components is applied by means of thermal spraying as an adhesive layer to a surface of the member to be coated;
(b) a layer predominantly comprising metallic components is applied by means of thermal or kinetic spraying as an intermediate layer to said adhesive layer; and
(c) a functional covering layer consisting of metal, a metal-carbide composite, oxide ceramics or mixtures of said materials is applied to said intermediate layer by means of thermal or kinetic spraying.

The invention relates to the generation of functional surfaces on fiber-reinforced composite materials by the application of thermal and kinetic spraying, wherein the protection of the surface of the member against wear, mechanical damages and adhesions, as well as an improvement of sheet release (release behavior) is considered to be of particular importance.

Fiber-reinforced composite materials, particularly those comprising a polymer matrix as well as carbon-fiber reinforced polymers, permit the production of members having extraordinary mechanical and physical characteristics, such as a low density, a high tensile and torsional strength, and a high modulus of elasticity or a high stiffness, respectively. A multiplicity of high-strength fiber materials may be used, including carbon fibers, glass fibers, silicon carbide fibers as well as fibers of many further oxides, carbides and other materials. Also a large multiplicity of polymeric materials may be used, including phenolic resins, epoxy resins and many other materials. The fibers may be very long and may be arranged in specific patterns, or they may be relatively short and randomly distributed. When long fibers are arranged in specific patterns, they may be oriented in a single direction, or they may be arranged in patterns which are designed to impart a two- or three-dimensional strength to the fiber-reinforced composite material. Thus, the mechanical characteristics of the structure of the fiber-reinforced composite material may be tuned to the specific requirements of a member.

Unfortunately, the surfaces of fiber-reinforced composite materials have a low wear resistance, particularly against adhesive, abrasive and erosive wear, and the adhesive and wetting characteristics thereof are insufficient for many applications, such as in the paper industry. Furthermore, they are frequently susceptible to oxidation and other types of corrosion, require thermal protection, and do not dispose of the required optical and electrical characteristics and the like. Therefore, the usability of fiber-reinforced composite materials is restricted in many applications or requires the use of metallic or ceramic inserts or coatings in those regions which are exposed to a contact with other members or material and thus are exposed to an increased wear.

Nevertheless, the use of rollers made of fiber-reinforced composite materials is of particular interest in the printing, paper and foil industry because they are substantially lighter and stiffer and thus can be handled more easier and more safely than rollers made for example from steel. Because of their lower inertia they furthermore need less energy and time for acceleration and braking. This allows cost savings not only in the handling and mounting but also in the operation. In order to provide the working surfaces of the rollers with the necessary characteristics, the rollers comprise a coating of metals, ceramics or carbides or mixtures thereof with plastic, which coating offers the required wear resistance and other necessary characteristics. When using thermal spraying processes, a large multiplicity of metallic and ceramic layers, cermet layers, i.e. carbide particles embedded in a metallic matrix, as well as some polymeric coatings can be produced.

The family of the thermal spraying processes includes the detonation spraying (amongst others the Super D-Gun™), the high velocity flame spraying and variations thereof, e.g. air-fuel spraying, the plasma spraying, the flame spraying and the electrical wire arc spraying. In most of the thermal coating processes the spraying material is heated in powder, wire or rod form to a temperature which corresponds to or is slightly above the melting point thereof, and droplets or melting particles of the material are accelerated in a gas stream. The droplets are directed to the surface of the substrate to be coated, where they adhere, solidify and form a continuous layer having a lamellar structure. In the case of the discontinuously operating detonation spraying process the layer is developed by individual, overlapping, rigidly linked spray spots. Such processes are known to the expert and are described in detail in numerous papers.

In spite of the fact that many attempts have been made to apply metal-, ceramic- or carbide-based thermal spray layers directly onto surfaces of fiber-reinforced composite materials, usually only a very poor adherence of the layer could be obtained. Frequently the layers did not adhere to the fiber-reinforced substrate or already flaked off upon deposition of a small layer thickness. Usually the surface of the member is roughened before application of the thermal spray layer in order to improve the adherence. Roughening mostly is effected by corundum blasting of the surface. Corundum blasting or other types of roughening of the surfaces to be coated, however, can result in an inacceptable erosion of the polymer matrix combined with an exposure of fibers. The latter can strongly impair the characteristics of the layer.

These and further problems for example became evident when applying the process described in U.S. Pat. No. 5,857,950. In this case the surface of a carbon fiber roller is sand blasted whereupon a zinc coating is applied as a heat shield. After again sand blasting the now zinc coated roller, an adhesive coating is applied, which coating may consist of a mixture of aluminum bronze and polyester. Subsequently, the adhesive coating is sand blasted, and a ceramic spray coating is applied and engraved. This process has shown to be inacepptable.

An alternative process is described in EP 0 514 640 B1. In this case, at first a layer consisting of a mixture of a synthetic resin and metallic particles dispersed therein is produced on the surface of a fiber-reinforced composite material. Upon curing of this layer, the surface is machined in order to expose the dispersed particles, so that the particle material can chemically combine with the material of an outer layer which is thermally sprayed onto the first layer. In spite of the fact that limited success may be attained with this process, the mixture of synthetic resin and particle material cannot properly adhere to the composite material and tends to form on the surface globules of material, whereby it is not suited for a commercial production.

In conformity with DE 100 37 212 A1 an adherend surface is applied on a plastic surface by a thermal spraying process, wherein this adherend surface may consist of zinc, zinc alloys, aluminum alloys and/or materials, such as nickel-aluminum alloys, which exothermally react in the course of the spraying process. Subsequently a functional coating likewise produced by a thermal spraying process is applied on the adherend surface.

Furthermore, EP 1 129 787 B1 describes a coating process in which a substrate of fiber-reinforced composite material is coated with a first layer containing only polymer, a second layer of a polymer/metal mixture and subsequently a thermal spray coating. In order to obtain a sufficient bonding strength between the layers, polymeric materials suited for the first two coating layers must be selected.

The problem basic to the present invention is to provide for coated fiber-reinforced composite materials in which the adherence of the coating layers to the composite material is further improved. The present invention particularly refers to the object to improve the wear resistance of fiber-reinforced plastic materials by combining two or more thermally or kinetically sprayed layer systems.

In conformity with the invention this problem is solved in that at first a composite consisting of organic and metallic components is applied by means of thermal spraying as an adhesive layer to the surface of the fiber-reinforced plastic material; that a thermally or kinetically sprayed layer predominantly comprising metallic components is applied to said adhesive layer as an intermediate layer; and that a thermally or kinetically sprayed functional covering layer consisting of metal, CERMET (a metal-carbide composite), oxide ceramics or mixtures of said materials or mixtures thereof with plastic material is applied to said intermediate layer. A mixture of two or more different materials may be used in spraying the metal-plastic composite which is applied as the adhesive layer. Instead of using during the spraying process two or more partial streams, the wire- or powder-shaped spray material itself may consist of the material composite.

The purpose of the aforementioned adhesive layer is to provide via its plastic component for an improved bonding to the matrix of the fiber-reinforced base material, and to simultaneously ensure a better wetting of any exposed fibers, what likewise is favorable for the adherence of the layers. The purpose of the metallic components of the adhesive layer is to enable a bonding to the metallic intermediate layer which is to be applied subsequently.

This intermediate layer is essential to the final application of the functional cover layer. It serves as a stable base for the mostly brittle, wear-resistant cover layer and simultaneously provides for a moderate matching of the moduli of elasticity of the adhesive layer and the cover layer. Furthermore, the metallic intermediate layer provides for a uniform distribution and dissipation of the heat introduced during the further coating of the member by e.g. high-velocity flame spraying or detonation spraying. Without a sufficient dissipation of heat, a local evaporation of the organic binder of the substrate body can occur that would result in debonding of the entire layer system.

The presently suggested process allows the production of coated members of fiber-reinforced composite material which are suited also for high dynamic loads, as well as members having a large layer area.

Preferred embodiments of the invention follow from the subclaims.

Preferably the organic component of the adhesive layer, e.g. polyester, amounts to between 5 and 60%, more preferably between 20 and 50%, and most preferably between 30 and 40%.

The metallic component of the adhesive layer, e.g. aluminum, copper or nickel, preferably amounts to between 40 and 90%, and more preferably between 60 and 80%.

The thickness of the adhesive layer preferably is between 0.1 and 2 mm, more preferably between 0.1 and 1 mm, and most preferably between 0.2 and 0.4 mm.

In a particularly preferred embodiment a 0.2 mm thick adhesive layer is applied by plasma spraying and consists of a metal-polyester composite. In an other particularly preferred embodiment a metal layer having a thickness of about 0.1 to 1 mm is sprayed by a thermal spraying process onto the adhesive layer.

In one embodiment the thickness of the intermediate layer is between 0.5 and 2 mm. Before applying the cover layer, the intermediate layer can be machined, e.g. by grinding or turning, in order to level out unevenness caused by preceding process steps.

It is favorable to apply the metallic intermediate layer by a method not involving combustion, such as arc spraying, plasma spraying or kinetic spraying, so that the heat input into the base material of fiber-reinforced plastic is kept as low as possible.

It is also favorable to use for the intermediate layer a metallic material having a ductility as high as possible.

In a further embodiment already the intermediate layer consists of a composite of metal and hard material, e.g. a kinetically sprayed aluminum-alumina composite layer, in order to provide for an increase of the strength.

When the coating of the fiber-reinforced material particularly aims at increasing the wear resistance, the functional cover layer of the layer system preferably consists of oxide ceramic (e.g. chromia) or of CERMET (metal-carbide composite, e.g. tungsten carbide particles embedded in a metallic cobalt matrix).

1. Method for coating a member of fiber-reinforced composite material, characterized in that
(a) at first a composite consisting of organic and metallic components is applied by means of thermal spraying as an adhesive layer to a surface of the member to be coated;
(b) a layer predominantly comprising metallic components is applied by means of thermal or kinetic spraying as an intermediate layer to said adhesive layer; and
(c) a functional covering layer consisting of metal, a metal-carbide composite, oxide ceramics or mixtures of said materials is applied to said intermediate layer by means of thermal or kinetic spraying.

2. Method as claimed in claim 1, characterized in that the organic component of the adhesive layer amounts to between 5 and 60%, preferably between 20 and 50%, and most preferably between 30 and 40%.

3. Method as claimed in claim 1, characterized in that the metallic component of the adhesive layer amounts to between 40 and 90%, and preferably between 60 and 80%.

4. Method as claimed in claim 1, characterized in that the thickness of the adhesive layer is between 0.1 and 2 mm, preferably between 0.1 and 1 mm, and more preferably between 0.2 and 0.4 mm.

5. Method as claimed in claim 1, characterized in that the metallic component of the intermediate layer amounts to 60% or more.

6. Method as claimed in claim 1, characterized in that the thickness of the intermediate layer is between 0.1 and 2 mm, preferably between 0.2 and 1 mm, and most preferably between 0.3 and 0.6 mm.

7. Method as claimed in claim 1, characterized in that the intermediate layer is machined before applying the covering layer.
